(19) United States
(12) Patent Application Publication
(10) Pub. No.: US 2014/0157183 A1
(43) Pub. Date: Jun. 5, 2014

(54) SYSTEM AND METHOD FOR THE SELECTION, LAYOUT, AND CONTROL OF ONE OR MORE HOSTED INTERACTIVE COMPUTER APPLICATION PROGRAMS USING A LIGHTWEIGHT SUPERVISOR COMPUTER APPLICATION PROGRAM

(71) Applicants: John Gordon Dorsay, Hamilton (CA); John Brian Dorsay, Hamilton (CA); Janet Lynn Park Dorsay, Hamilton (CA)

(72) Inventors: John Gordon Dorsay, Hamilton (CA); John Brian Dorsay, Hamilton (CA); Janet Lynn Park Dorsay, Hamilton (CA)

(21) Appl. No.: 13/690,604

(22) Filed: Nov. 30, 2012

(51) Int. Cl. G06F 3/048

(52) U.S. Cl. CPC G06F 3/048
USPC 715/781

(57) ABSTRACT

The present concept is a lightweight supervisor computer application program for aggregating hosted interactive computer application programs. The lightweight supervisor computer application program is executed on a computer with an operating system. The lightweight supervisor computer application program causes the computer to create a new lightweight supervisor computer application program environment for execution and display of one or more hosted interactive computer application programs selected by user, wherein the lightweight supervisor computer application program environment provides display and other services to each hosted interactive computer application, which services are otherwise provided by the operating system and desktop environment. The hosted interactive computer application programs also simultaneously hosts and displays the aggregation of all selected hosted interactive computer applications in the lightweight supervisor computer application program environment.

### FIELD OF THE INVENTION

The present invention relates to the presentation and layout of one or more interactive computer application programs, and more particularly to customizing presentation and layout information in such a way that the information is preserved between user sessions.

### BACKGROUND

Computer systems are commonly used for viewing and manipulating different types of information. A few of the more well-known types of information include alphanumeric text, graphics, and other forms of information. In order to manipulate these different types of information, various computer programs known in the art as application programs have been developed and made available in the prior art. Such application programs include word processing programs, spreadsheet programs, data base programs, input/output or communications programs, drawing or graphics generation programs, and other application programs for viewing and manipulating a particular defined data type.

An operating system (OS), as known in the art, is a collection of software programs that provide communication between application programs running on a computer and the computer's hardware and system resources. Today, many operating systems provide a graphical user interface for users to control application programs on a computer. For example, operating systems, such as Microsoft Windows™ and Apple Macintosh™, often provide “windows” and icons to control each program on a computer, e.g., by using a mouse to “point and click.” As a result, typical user interfaces use a variety of windows and icons to control each application program. Such an architecture is described in the art as “layered”, wherein the user interacts with windows and icons of application programs at the application program layer, the application program interacts with the OS at the OS layer, and the OS interacts with computer resources at the hardware layer.

One component of this invention is a Lightweight Supervisor Computer Application Program (LSA), which provides an additional layer in the layered architecture. This additional layer sits between the OS and certain application programs such that these application programs interact with the LSA at the LSA layer, rather than with the OS. The LSA, in turn, interacts with the OS at the OS layer on behalf of these application programs.

Another component of this invention is Hosted Interactive Computer Application Programs (HIAs), which are those programs that interact with the LSA rather than with the OS.

In some embodiments, the LSA provides a Restricted Hosting Environment (RHE) to the HIA in which execution of the HIA is contained. In an RHE, the LSA limits HIA access to system resources by presenting a subset of available system resources to the HIA as if the LSA was presenting all system resources. For example, the LSA might provide an RHE which presents a 640 by 480 pixel display area, when the LSA itself has access to a 1920 by 1080 pixel display area. An HIA executing in full-screen mode in such an RHE would be limited to the 640 by 480 pixel display area of the RHE.

Typical user interfaces become very complex as the number of interactive programs executed on a computer increase. Recent advances in technology have allowed a dramatic increase in the number of programs that can be supported on a computer. Moreover, the number of interactive programs simultaneously executed on a computer has increased dramatically with the popularity of applications supported over the Internet. For example, it is now common for users to simultaneously operate a wide variety of programs, including: word processing; games, electronic mail; instant messaging; network or online applications; multi-media applications; etc. For users who are pursuing a particular task that involves the simultaneous operation of multiple interactive computer programs, the current art requires the user to perform multiple steps to maintain consistent selection, layout and control states of the desired interactive computer programs. Therefore, it would be desirable to simplify the preservation and restoration of the selection, layout and control states of multiple interactive computer programs.

As known in the art, every graphical-based interactive application program creates at least one window that serves as an interface between a user and the application. The embodiments described hereinafter are described in reference to windows, however, it should be understood that the present invention is not limited to displaying windows, and different graphical user interfaces or non-window based messaging, widgets, or icons could also be used as parts of managed workspaces.

Many application programs may also create windows to perform tasks related to the main window, and each window may display output as well as receive input from a user. The displayed output may include text or graphics such as news updates or any charts or graphs that are provided by applications running on a client device or outside sources. Each window can have a number of predefined attributes such as a window's style, position, or size, for example. A window's style defines different aspects of the window's appearance and behavior. A window's position may be defined as the coordinates of its upper left corner in relation to some predefined location on a display. Then, a window's size may vary based on a size of a display interface. However, some applications may create windows with a client area having a particular minimum size due to the visibility limitations associated with each window.

In addition to the window's size, position, and style, there are many ways to control a window's position in relation to other windows. For example, some windows could be foreground windows while others could be background windows. Typically, each process can create multiple windows. The window with which the user is currently working is called a foreground window, and all other windows are called background windows. Also, a user can at any time set a foreground window by some method such as clicking any displayed windows or selecting a predetermined key combination. By default, users manage each window's position independently of other windows. If a user wishes to minimize the windows associated with several applications while leaving other windows open, each must be minimized separately.

Frequently users desire concurrent access to multiple application programs. For example, an author using a word processing application program to compose an article may desire access to a web browser application program to facilitate reference to some particular remote content, and a pdf reader application program to facilitate reference to a local document. Currently, such a user can open a word processor application program, a web browser application program, and a pdf reader application program for each of these purposes. Then the user can switch between “maximized” instances or each application program, in which case only the “foreground” or active application program is visible at any given time, or the user can arrange the windows associated with each application program in such a way that two or more are simultaneously visible. In the latter case, the user can either perform this arrangement each time the desired applications are used, or the user can group the windows associated with multiple applications using virtualization techniques.

Using the current art, the user can create a “virtual desktop”, and dedicate the virtual desktop to a particular group of application programs, which allows the user to move between application groups on multiple desktops after arranging the application program windows as desired. In this case, the grouped application programs must be left “open” in order to remain accessible, which might not be desirable. Alternatively, the user can also group windows associated with multiple applications by creating a “virtual machine”, and dedicating the virtual machine to an application group. In this case, when the user wishes to “open” the group of applications, the user must open the previously-created virtual machine. The time involved in opening the virtual machine, the overhead associated with virtualizing all aspects of the virtual machine's hardware, and the space required to store the physical data associated with the virtual machine might not be desirable.

Some embodiments of this invention permit the user to form groups of application programs without resorting to virtualization techniques and the attendant overhead and limitations.

### BRIEF DESCRIPTION OF THE DRAWINGS

Example embodiments of the present invention are described herein with reference to the following drawings, in which:

FIG. 1 describes an embodiment which uses a full-screen, frameless LSA window to select, layout, and control one or more HIAs.

FIG. 2 describes an embodiment in which a LSA manages the window locations of HIAs.

FIG. 3 describes a workflow in which an embodiment uses a LSA to start one or more HIAs at stored window positions.

FIG. 4 describes a workflow in which an embodiment uses a LSA to proxy messages between the OS and HIAs.

FIG. 5 describes a workflow in which an embodiment uses a LSA to prompt a user to select an existing HIA configuration or to create a new configuration.

FIG. 6 provides sample screens of a computer before and after executing an LSA.

### DETAILED DESCRIPTION

The invention is illustrated by way of example and not by way of limitation in the FIGS. of the accompanying drawings in which like references indicate similar elements. It should be noted that references to “an” or “one” embodiment in this disclosure are not necessarily to the same embodiment, and such references mean at least one.

While details of certain embodiments are discussed in this section, it should be clear that other suitable embodiments exist and can be used to achieve similar capabilities. Further, some of these embodiments may include additional functionality not discussed herein, and/or may not contain all of the functionality described herein.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one (or more) of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

One embodiment of this invention consists of a LSA which executes in a particular computing environment. This LSA hosts one or more HIAs as selected by a user. The LSA presents itself to the HIAs as if the LSA is the entire “desktop” component of an OS shell, but it presents itself to the user as an application program running within the user's selected OS environment. Such an embodiment is suitable for HIAs which can be started with their respective windows at defined co-ordinates within the LSA window.

One embodiment of this invention consists of a LSA which executes in a particular computing environment. This LSA hosts one or more HIAs as selected by a user. The LSA presents the display region assigned to each HIA as if such region is the entire “desktop” component of an OS shell, but it presents itself to the user as an application program running within the user's selected OS environment. Such an embodiment is suitable for HIAs which can be started with their respective windows “maximized”.

One embodiment of this invention combines attributes of the two previously described embodiments in such a way that one or more HIAs can be started with their respective windows at defined co-ordinates within the LSA window, while the remaining HIAs can be started with their respective windows maximized.

In one embodiment the LSA itself is not displayed, rather the LSA preserves information regarding desktop locations of HIAs, and uses this information to restore the HIAs to these saved locations when it is executed.

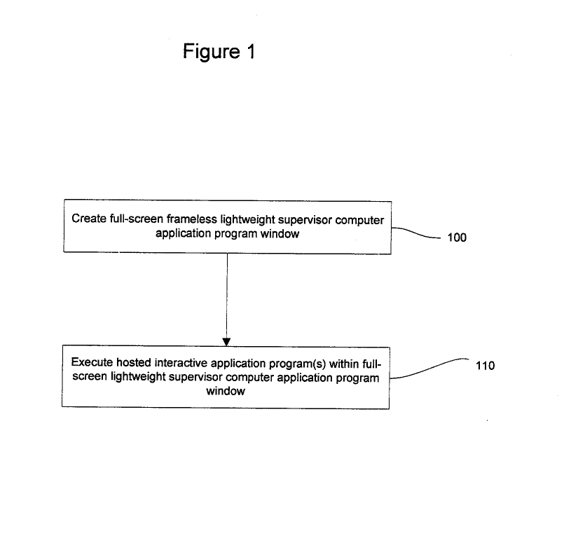

In one embodiment the LSA itself is rendered with neither a frame nor OS widgets. When rendered full-screen it thus conceals the entire OS desktop, and provides no access to OS widgets to reveal the desktop, making it suitable for kiosk mode applications. One such embodiment can be used with individual HIAs that preserve their location from session to session. It is described in FIG. 1, in which the LSA creates a full-screen frameless container window at box 100, then executes HIA(s) within the full-screen container window at box 110.

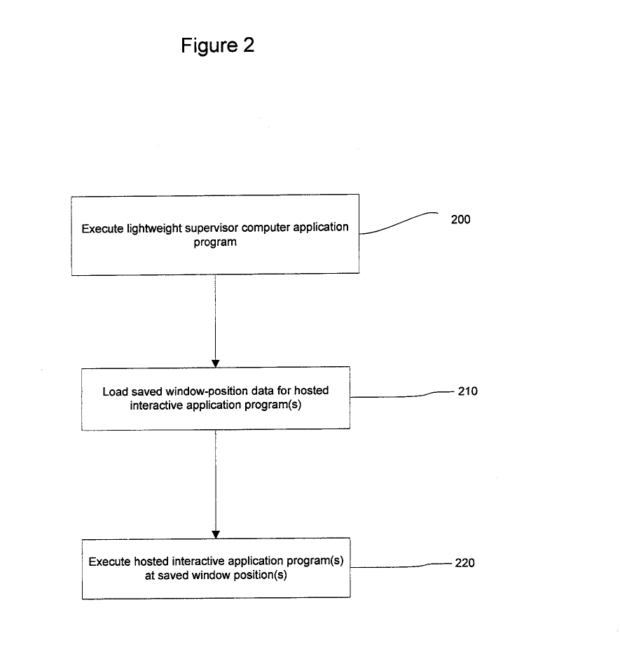

In one embodiment the LSA preserves preference information about the position and size of HIAs within its visible environment. The LSA has the ability to save and restore these preferences and the associated HIAs on user start up without user intervention, which allows the user to return to a workspace with a previously configured layout of HIAs. FIG. 2 describes one embodiment in which the LSA manages the window locations of the HIAs. In it, the LSA creates a full-screen frameless container window at box 200, loads the saved window positions of the HIAs at box 210, then executes the HIA(s) the saved window positions within the full-screen container window at box 220.

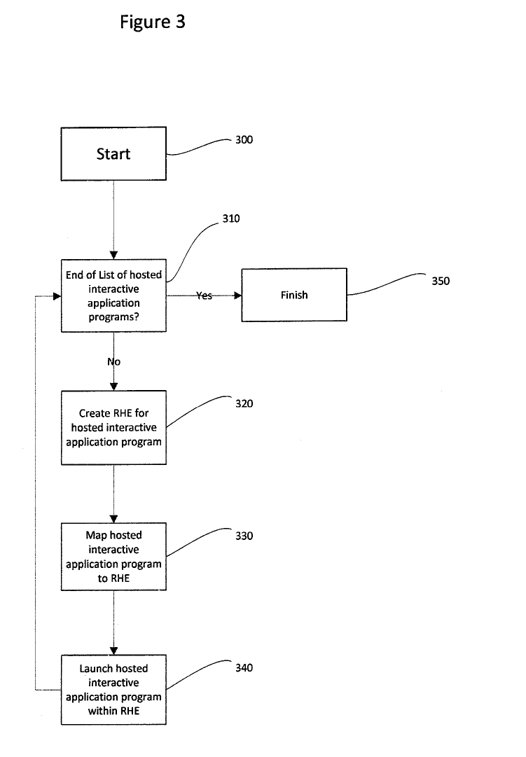

FIG. 3 describes a workflow for one embodiment to start one or more HIAs at stored window positions using stored startup parameters. The workflow starts at box 300. Control then passes to box 310, at which point it is determined whether or not there are further startup parameters to process.

At box 310, if there are no further unprocessed startup parameters, the workflow ends at box 350 and the HIAs are ready for user interaction. Otherwise, control proceeds to box 320.

At box 320, the LSA creates a RHE in which to host a particular HIA in accordance with the strartup parameters. Control then passes to box 330.

At box 330, the LSA maps the HIA to the RHE in which it will execute. Control then passes to box 340.

At box 340, the LSA executes the HIA within the mapped RHE. Control then returns to box 310.

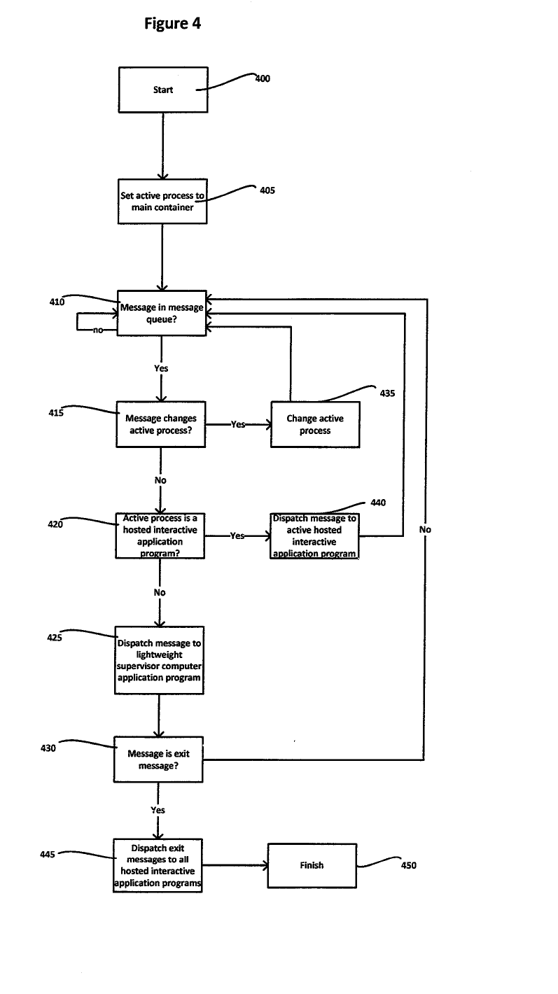

In one embodiment a LSA acts as a proxy for messages between HIAs and the OS which allows the LSA to modify these messages as desired. This allows the user, for example, to see the expected right click context menus when a user clicks on a HIA's visible window. This also allows the LSA to intercept and manage any input and/or output to and/or from the HIA window. FIG. 4 describes the workflow for the LSA to proxy messages using the process-RHE map described in FIG. 3. The workflow starts at box 400, and control is passed to box 405 in which the LSA itself is set as the “active” process. Control is then passed to box 410.

At box 410, the LSA determines whether or not there are any waiting messages. If there are not, control remains with box 410 where the LSA continues to check for waiting messages. Otherwise, there is a waiting message, and control is passed to box 415.

At box 415, the LSA determines if the waiting message changes the active process. If it does, control is passed to box 435. Otherwise, the message does not change the active process and control is passed to box 420.

At box 420, the LSA determines if the active process is a HIA. If it is, control is passed to box 440. Otherwise, the active process is not a HIA (therefore it is the LSA), and control passes to box 425.

At box 425 the message is dispatched to the LSA. Control is then passed to box 430.

At box 430, the LSA determines if the message is an “exit message”. If it is not an exit message, control returns to box 410. Otherwise, the message is an exit message and control is passed to box 445.

At box 435, the active process is updated in accordance with the message. Control then returns to box 410.

At box 440, the message is dispatched to the active HIA. Control then returns to box 410.

At box 445 exit messages are dispatched to each HIA, after which control passes to box 450, where the workflow ends.

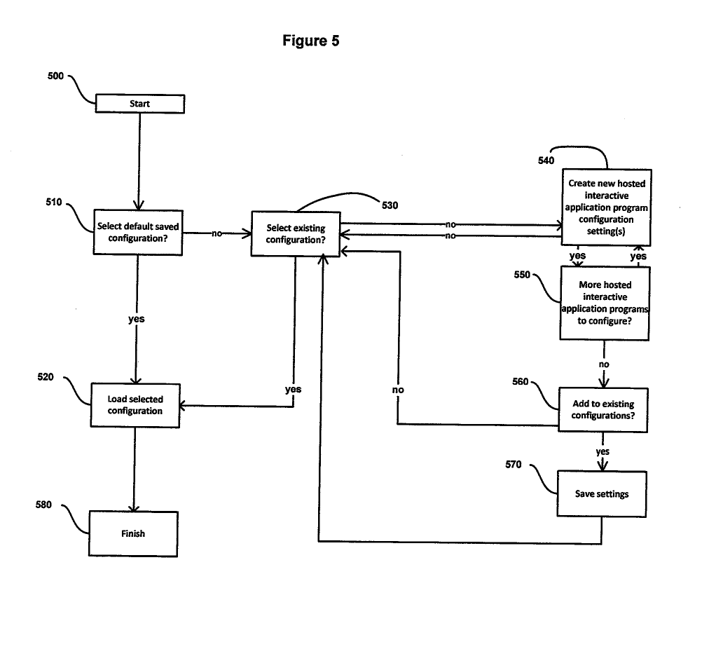

In one embodiment the user configures particular distinct startup parameters for HIAs. This allows the user to run independent instances of the same application program, such as two browser instances, each browser instance possibly associated with distinct profiles. FIG. 5 describes the workflow for an embodiment in which the user may have previously saved such a configuration. The workflow starts at box 500, which passes control to box 510.

At box 510, an LSA prompts the user to select the default saved configuration settings. If the user selects the default settings, control is passed to box 520. Otherwise, the user does not select the default settings, and control is passed to box 530.

At box 520 the LSA loads the selected configuration set. Control then is passed to box 580 and the end of this workflow.

At box 530, the LSA prompts the user to select an existing configuration. If the user selects an existing configuration, control is passed to box 520. Otherwise, the user does not select an existing configuration, and control is passed to box 540.

At box 540, the user is prompted to create a new configuration set. If the user creates a new configuration set, control is passed to box 550. Otherwise, the user does not create a new configuration set, and control is returned to box 530, where the LSA prompts the user to select from a list of existing configuration sets.

At box 550, the LSA prompts the user to create additional configuration sets. If the user creates additional sets, control returns to box 540. Otherwise, the user does not create additional sets, and control passes to box 560.

At box 560, the LSA prompts the user to add the current configuration to existing configurations settings, that is, to save the current configuration settings. If the user accepts saving the current settings, control is passed to box 570. Otherwise, the user declines saving the current settings, and control is returned to box 530.

At box 570 the LSA adds the current configuration to existing configurations settings. Control then is passed to box 530.

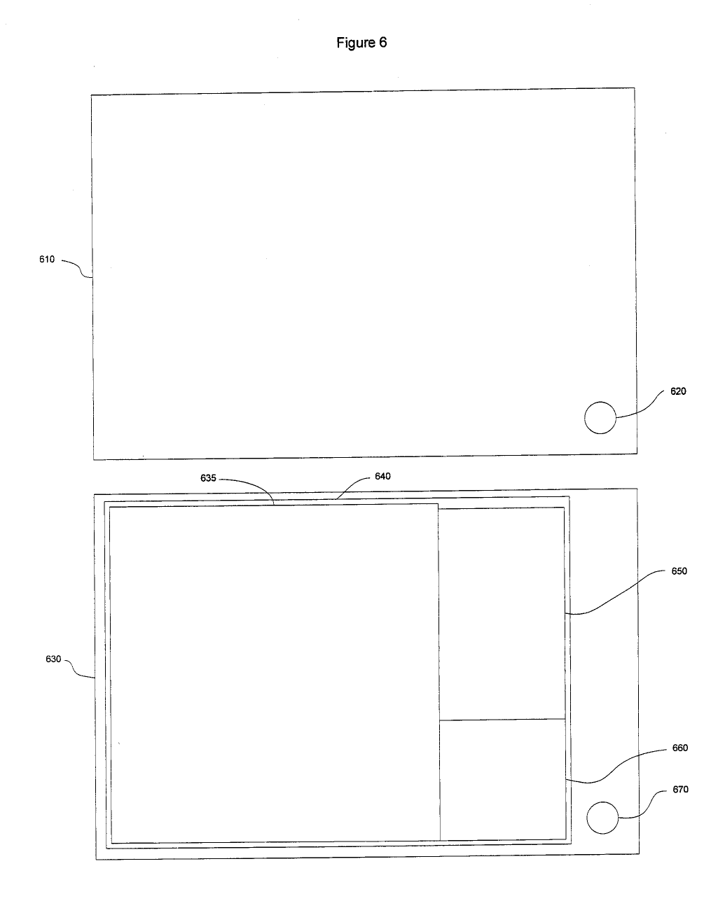

FIG. 6 provides sample screens of a computer before and after executing an LSA. Box 610 illustrates a computer “desktop” which is empty except for an “icon” represented by circle 620. In this embodiment, the user executes the LSA by “double-clicking” the icon at circle 620.

Box 630 illustrates the same computer desktop after the user has executed the LSA, and the LSA has executed its HIAs. In this embodiment, the LSA presents itself to the HIAs as if the LSA is the entire “desktop” component of an OS shell, but it presents itself to the user as an application program running within the user's selected OS environment. Box 640 is the window created by the LSA in which to host HIAs. Box 635 is the window created by one HIA, as are box 650 and box 660. Circle 670 is the icon which the user double-clicked to execute the LSA.

The foregoing description of embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated.

We claim:

1. A lightweight supervisor computer application program (LSA) for aggregating hosted interactive computer application programs (HIA(s)), the LSA when executed on a computer with an operating system (OS) the LSA causes the computer to:
a) create a new LSA environment for execution and display of one or more HIA(s) selected by user, wherein the LSA environment provides display and other services to each HIA, which services are otherwise provided by the OS and desktop environment, when an HIA is executed directly by the OS rather than by the LSA;
b) simultaneously host and display the aggregation of all selected HIA(s) in the LSA environment, wherein each HIA appears within a display region limited to a LSA defined display region, rather than within the desktop display region as each would appear when executed directly on the desktop;
c) wherein each HIA may be displayed in the LSA display region as a running application and each HIA may execute concurrently within the LSA environment.

2. The LSA claimed in claim 1 wherein the HIA(s) are launched at user defined pre-selected coordinates on the LSA display region environment.

3. The LSA claimed in claim 2 wherein the user defines preselected startup parameters for one or more HIA(s).

4. The LSA claimed in claim 3 wherein the LSA creates a Restricted Hosting Environment (RHE) in which to host an HIA using the preselected startup parameters.

5. The LSA claimed in claim 1 wherein the user causes the LSA to create one or more RHE(s) in which to host HIA(s) and to store startup parameters wherein, on subsequent executions, the LSA will execute the same HIA(s) in RHE(s) configured in accordance with the stored parameters.

6. The LSA claimed in claim 1 wherein the LSA enables communication between the OS and each HIA.

7. The LSA claimed in claim 6 wherein the LSA intercepts and modifies communication between the OS and one or more HIA(s).

8. The LSA claimed in claim 3 wherein the startup parameters include preselected HIA startup parameters.

9. The LSA claimed in claim 8 wherein the startup parameters include displaying the HIA(s) to appear as if they are operating within the OS environment.

10. The LSA claimed in claim 3 wherein the startup parameters include causing the LSA to completely obscure or otherwise replace the OS desktop display region.

11. The LSA claimed in claim 3 wherein the startup parameters include causing the running HIA(s) to occupy the entire LSA display region.

12. The LSA claimed in claim 3 wherein the ability of the user to alter the size and location of the LSA display region with respect to the OS display region is disabled.

13. The LSA claimed in claim 3 wherein the ability of the user to alter the size and location of the HIA(s) with respect to the LSA display region is disabled.
